(19) United States
(12) Patent Application Publication
(10) Pub. No.: US 2006/0080671 A1
(43) Pub. Date: Apr. 13, 2006

(54) Systems and methods for opportunistic frame queue management in SAS connections

(76) Inventors: Brian A. Day, Colorado Springs, CO (US); Paul J. Smith, Colorado Springs, CO (US); Parameshwar Ananth Kadekodi, Norcross, GA (US); Ganesan Viswanathan, Duluth, GA (US)

Correspondence Address: LSI LOGIC CORPORATION, 1621 BARBER LANE, MS: D-106, MILPITAS, CA, 95035, US

(21) Appl. No.: 10/963,613

(22) Filed: Oct. 13, 2004

(51) Int. Cl. G06F 3/00

(52) U.S. Cl. 719/314

(57) ABSTRACT

Methods and structures for opportunistically managing queued frames directed from a first SAS device to one of multiple other SAS devices coupled to the first device. A SAS application layer is coupled to a plurality of SAS transport layers through an arbitrated communication medium. Each transport layer is associated with a corresponding SAS device. Queued frames from the SAS application layer may be maintained in a per-device queuing structure associated with the SAS application layer. Upon receipt of an indication of readiness from the SAS transport layer that wins arbitration, a next SAS frame queued for the corresponding SAS device is unqueued and forwarded to the SAS device regardless of the number of other SAS frames queued for other SAS devices that lost the arbitration.

### BACKGROUND OF THE INVENTION

1. Field of the Invention

The invention generally relates to managing connections in a SAS domain. More specifically, the invention relates to simplified methods and structures to manage frames queued for transmission to devices in a SAS domain.

2. Discussion of Related Art

Small Computer Systems Interface (“SCSI”) is a set of American National Standards Institute (“ANSI”) standard electronic interface specifications that allow, for example, computers to communicate with peripheral hardware. Common SCSI compatible peripheral devices may include: disk drives, tape drives, Compact Disc-Read Only Memory (“CD-ROM”) drives, CD Read/Write (“CD-RW”), digital versatile disk (“DVD”) drives, printers, scanners, etc. SCSI as originally created included both a command/response data structure specification and an interface and protocol standard for a parallel bus structure for attachment of devices. SCSI has evolved from exclusively parallel interfaces to include both parallel and serial interfaces. “SCSI” is now generally understood as referring either to the communication transport media (parallel bus structures and various serial transports) or to a plurality of primary commands common to most devices and command sets to meet the needs of specific device types as well as a variety of interface standards and protocols.

The collection of primary commands and other command sets may be used with SCSI parallel interfaces as well as with serial interfaces. Examples of serial interface transport media and protocol standards that support SCSI command processing include: Fibre Channel, Serial Bus Protocol (used with the Institute of Electrical and Electronics Engineers 1394 FireWire physical protocol; “IEEE 1394”) and the Serial Storage Protocol (“SSP”).

SCSI interface transports and commands are also used to interconnect networks of storage devices with processing devices. For example, serial SCSI transport media and protocols such as Serial Attached SCSI (“SAS”) and Serial Advanced Technology Attachment (“SATA”) may be used in such networks. These applications are often referred to as storage networks. Those skilled in the art are familiar with SAS and SATA standards as well as other SCSI related specifications and standards. Information about such interfaces, media, protocols and commands is generally obtainable at the website http://www.t10.org.

Such SCSI storage networks are often used in large storage systems having a plurality of disk drives to store data for organizations and/or businesses. The network architecture allows storage devices to be physically dispersed in an enterprise while continuing to directly support SCSI commands directly. This architecture allows for distribution of the storage components in an enterprise without the need for added overhead in converting storage requests from SCSI commands into other network commands and then back into lower level SCSI storage related commands.

A SAS network typically comprises one or more SAS initiators coupled to one or more SAS targets via one or more SAS expander devices. In general, as is common in all SCSI communications, SAS initiators initiate communications with SAS targets. In particular, SAS initiators use a process often referred to as “discovery” to determine the topology of devices in the network (i.e., to discover other SAS initiators, SAS expanders and SAS targets). Once such information is known, initiators generally establish the first contacts with a given target device. The initiator issues an “open” request (i.e., a SAS OPEN address frame) to an identified SAS target to establish a first connection with the SAS target device. Once the first connection is so established, either the SAS initiator or the SAS target device may re-establish a connection. For example, a connection may be established initially by the initiator, closed after some transactions are exchanged, and then re-opened by the same initiator for a subsequent sequence of transactions. Or, for example, a SAS target device may have deferred processing of a transaction received from an initiator. At some later time when the SAS target is ready to proceed, the target device may “open” a connection back to the initiator that originally requested the deferred transaction.

In SAS protocol exchanges, frames (including commands) may be queued to be transmitted to a SAS device (i.e., from an initiator device to a target device). In general, higher layers of the SAS protocol stack model (i.e., system processes and user application programs) interface with one or more transport layers to direct frames to a device corresponding to the transport layer and logically (as well as physically) connected thereto. The transport layer processing element may be embodied as programmed instructions operating within the same processing elements as the application layer or may be a distinct electronic component coupled to the host system (where the system or user processes are operable) via a bus structure such as a PCI bus or other common transport interface structure. Regardless of the degree of integration between the application layer and one or more transport layers, each may be referred to herein as a “processing element” to represent either architectural structure or other equivalent structures.

In general, the higher layer processing elements generate frames to be applied to a device via a corresponding transport element. The transport layer processing elements receive the generated frames and forward them through corresponding link layer processing elements to the identified SAS device intended to receive the frames (the target device). The frames to be transmitted are typically queued in some queuing structure accessible to the transport layer processing elements. Frames may remain in the queue until they are successfully transmitted through the link layer processing element to the identified target device.

Several user application or system processes may be simultaneously generating and queuing frames for corresponding devices on corresponding transport layers. The SAS devices are coupled to the corresponding transport layer processing elements through a SAS domain that may include one or more SAS expanders. Each transport layer processing element may be responsible for communicating with each of multiple devices identified by one or more application layer processing elements. The SAS domain is, in essence, an arbitrated bus structure. A device coupled to a corresponding transport layers may disconnect an established connection to the transport layer when the device requires some processing time to prepare to receive frames to be transmitted (or to prepare to return requested data in a read operation). When the device disconnects the established connection, it later re-connects (e.g., re-selects) the corresponding transport layer processing element when it is ready to receive the transmitted frames. Re-connecting or re-selecting the transport layer through the SAS domain involves a form of arbitration. Multiple devices may attempt to re-connect at substantially the same time. The SAS domain essentially arbitrates among such a plurality of devices attempting to re-connect to the same transport layer. The transport layer may have commenced other connections and transmission during the period that a disconnected device was preparing to receive frames. Therefore, a plurality of devices may be in similar disconnected states with a given transport layer processing element. The order in which the devices attempt to re-connect to the transport layer is not necessarily the same order in which frames were generated for transmission to the devices. Further, the arbitration processing within the SAS domain adds yet another variable factor in the sequence in which the device will be re-connected. Most arbitration processes deliberately impose a degree of randomness in selecting among a plurality of arbitrating devices. Such randomness imparts a degree of fairness in determining which device wins an arbitration process.

If the device that wins such an arbitration in the SAS domain does not match the device for which a next frame is queued for the transport layer, the readiness of the device may be ignored and the arbitration process may be repeated until the device for which the next frame is queued wins its arbitration to re-connect with the transport layer. Prior techniques may therefore skip opportunities to transmit a next queued frame because the order in which devices re-connect to the transport layer does not match the order in which frames are queued. Such prior techniques are wasteful of processing resources in the host system and wasteful of bus bandwidth on the shared, common transport interface (i.e., the SAS domain coupling the transport processing elements to the SAS devices).

In view of the above discussion, it is evident that there is an ongoing need for improved structures and methods for better utilizing available processing resources and communication bandwidth associated with an interconnect bus used to couple a host system to a plurality of SAS transport processing elements.

### SUMMARY OF THE INVENTION

The present invention solves the above and other problems, thereby advancing the state of useful arts, by providing methods and associated structures for opportunistic utilization of processing resources and available bandwidth associated with an interconnect between host system processes and target SAS devices. Regardless of the order in which frames are queued for multiple SAS devices, when a target device wins arbitration in the SAS domain and indicates its readiness to receive a frame, a queued frame will be returned to the device regardless of the order in which frames were queued for multiple SAS devices. In accordance with features and aspects hereof, frames are queued on a per device basis such that a next frame may be identified for any responding target device regardless of which target was most recently contacted by the initiator's transport layer processing element.

A first feature hereof provides a SAS device comprising: a SAS application layer processing element; and a plurality of SAS transport layer processing elements each communicatively coupled to the SAS application layer processing element and wherein each SAS transport layer processing element is adapted to exchange information received fro the SAS application layer processing element with one or more of the other SAS devices through an arbitrated SAS domain interface, wherein each SAS transport layer processing element is adapted to retrieve a next frame to transmit to a winning device of the plurality of other SAS devices each time the winning device wins arbitration on the arbitrated SAS domain.

Another aspect hereof further provides a queue manager communicatively coupled to the SAS application layer processing element and coupled each of the plurality of SAS transport layer processing elements and adapted to queue SAS frames generated by the SAS application layer processing element.

Another aspect hereof further provides that each SAS transport layer processing element is operable to retrieve a next queued SAS frame from the queue manager when the winning device wins arbitration regardless of the order in which the SAS frames are queued in the queue manager for other SAS devices.

Another aspect hereof further provides that the queue manager further comprises: a plurality of SAS frame queues each associated with a corresponding one of the other SAS devices.

Another feature hereof provides a SAS transport layer coupled to an associated SAS application layer and coupled to a SAS device through an arbitrated SAS domain, the SAS transport layer further comprising: a SAS application layer interface element adapted to couple the SAS transport layer to a SAS application layer; a SAS link layer interface to couple the SAS transport layer to a SAS domain; and a SAS frame transmit controller for retrieving a next SAS fame for transmission to the associated SAS device in response to the associated SAS device winning arbitration through the arbitrated SAS domain regardless of which SAS device the SAS frame transmit controller was last contacted by the SAS frame transmit controller.

Another aspect hereof provides that the SAS frame transmit controller further comprises: a match comparator to determine whether the SAS transport layer is presently requesting transmission of a SAS frame to the associated SAS device; a match connection module to retrieve a next frame from the SAS application layer in response to a determination that the SAS transport layer is presently requesting transmission of a SAS frame to the associated SAS device; and a mismatch connection module to request a next frame for the SAS device from the SAS application layer in response to a determination that the SAS transport layer is presently requesting transmission of a SAS frame to the another SAS device.

Another feature hereof provides a method operable in a SAS transport layer for obtaining a next SAS frame for transmission to an identified SAS device coupled to the SAS transport layer through an arbitrated SAS domain, the method comprising: receiving a request from the SAS application layer to transmit a SAS frame to the identified SAS device; attempting to connect to the identified SAS device; detecting a connection between the transport layer and a winning SAS device that won an arbitration process on the arbitrated SAS domain; and transmitting a next SAS frame to the winning SAS device regardless of whether the winning SAS device is the same device as the identified SAS device.

Another feature hereof further provides that SAS frames to be transmitted are queued in a queue manager communicatively coupled to the SAS transport layer and wherein the step of transmitting further comprises: unqueuing the next frame to be transmitted from a first queue in the queue manager if the winning SAS device is the same device as the identified device wherein the first queue is associated with the identified SAS device; and unqueuing the next frame to be transmitted from a second queue in the queue manager if the winning SAS device is not the same device as the identified device wherein the second queue is associated with the winning SAS device.

Another aspect hereof further provides that the step of detecting further comprises: detecting a re-connect from the winning SAS device.

### BRIEF DESCRIPTION OF THE DRAWINGS

FIG. 1 is a block diagram of a SAS controller embodying features and aspects hereof.

FIG. 2 is a block diagram of a queue manager as in FIG. 1 embodying features and aspects hereof.

FIG. 3 is a block diagram of a SAS transport layer as in FIG. 1 embodying features and aspects hereof.

FIG. 4 is a flowchart describing operation of a SAS transport layer operable in accordance with features and aspects hereof.

FIG. 5 is a flowchart describing operation of a SAS application layer operable in accordance with features and aspects hereof.

### DETAILED DESCRIPTION OF THE DRAWINGS

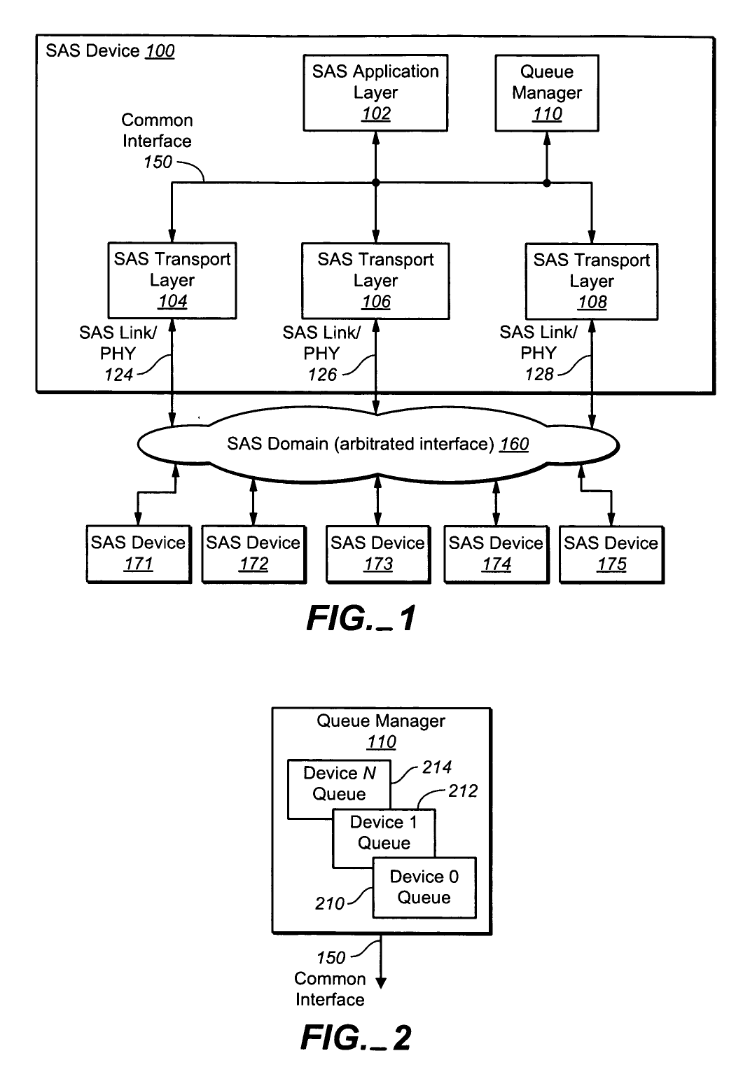

FIG. 1 is a block diagram of a SAS device 100 embodying features and aspects hereof. SAS application layer 102 represents system and application processes operable to generate data for transmission to any of a plurality of other SAS devices coupled to SAS device 100. SAS transport layers 104, 106, and 108 are each SAS transport layer elements coupled to the SAS application layer through common interface 150. Each SAS transport layer 104, 106, and 108 is coupled to a corresponding SAS link/PHY layer and medium 124, 126, and 128, respectively, for communication to corresponding other SAS devices 171-175 through SAS domain 160. SAS domain 160 may comprise any number of SAS expanders and other network devices useful in a SAS communication application. SAS link/PHY layers 124, 126, and 128 may each comprise well known circuits and/or processing elements to perform SAS link layer processing and PHY link layer control.

Associated with SAS application layer 102 and transport layers 104, 106, and 108 is queue manager 110 for managing one or more queues for generated SAS frames awaiting transmission to corresponding, identified other SAS devices 171-175. In general, SAS application layer 102 generates data to be transmitted to an identified other SAS device 171-175 via an associated identified SAS transport layer 104, 106, or 108 via SAS domain 160. The data to be transmitted is broken into one or more SAS frames in accordance with well-known SAS standards and protocols. SAS frames so generated are queued in queue manager 110 awaiting transmission through an identified SAS transport layer (104, 106, or 108) corresponding with an identified SAS device 171-175.

SAS application layer 102, queue manager 110, and SAS transport layers 104, 106, and 108 may be embodied in distinct processing elements coupled by the common interface 150. Alternatively, application layer 102, transport layers 104, 106, and 108 and queue manager 110 may be embodied as programmed instructions within a common processing element such that common interface 150 represents well known interprocess communication techniques and structures. In one exemplary embodiment, SAS transport layers 104, 106, and 108 are embodied in individual processing elements each coupled through the common interface 150 to yet another processing element providing SAS application layer 102 functionality and queue manager 110 through a PCI bus or through an AMBA AHB bus—each an exemplary embodiment of common interface 150. Other well-known bus architectures and other communication media may be used as common interface 150.

The SAS application layer 102 sends a message to an identified SAS transport layer (104, 106, or 108) corresponding to the desired, identified SAS device 171-175 intended to receive the generated data. The generated data is provided to queue manager 110 to await retrieval by the proper transport layer processing element 104, 106, or 108. The identified SAS transport layer (104, 106, or 108) will receive the message from the application layer 102 and attempt to transmit the first queued frame for the corresponding identified SAS device (171-175).

The SAS device (171-175) may not be presently ready to receive the transmitted frame. Rather, additional processing may be required by the identified SAS device to prepare for receipt of the generated SAS frames. The SAS device (171-175) may respond to the attempted transmission from the SAS transport layer processing element 104, 106, or 108 indicating that it is not presently ready to receive the SAS frame data. Such an indicia may be, for example, in the form of a disconnect message in accordance with the SCSI protocol or other equivalent indicia of the state of the target device.

At some later point, when the SAS device has completed preparations to receive a frame, it will attempt to re-connect (e.g., re-select) the target layer processing element to indicate that frame transmission may be restarted. As noted above, the SAS devices 171-175 arbitrate through elements of SAS domain 160 to attempt to re-establish the connection with the corresponding SAS transport layer (104, 106, or 108). Arbitration is necessary because numerous target devices may have been in communication with the corresponding transport layer 104, 106, or 108. Multiple of those target devices may attempt to re-establish a connection substantially simultaneously. Arbitration processes controlled by SAS domain 160 will select one of the multiple SAS devices attempting to re-establish connection to one of the transport layers 104, 106, or 108.

As is well known in such arbitrated communication structures, each SAS device may require different times to prepare for receipt of frames. Further, some degree of randomness or fairness may be imposed by arbitration techniques among the multiple SAS devices 171-175 so that each may fairly obtain access to the shared, arbitrated SAS domain 160. Therefore, the SAS device that wins the arbitration may not be the SAS device for which the corresponding transport layer most recently generated a request. Rather, the SAS devices 171-175 may win arbitration to re-establish a connection in a pseudo-random or somewhat arbitrary sequence (i.e., a fair sequence not necessarily the same as the sequence in which requests are generated by SAS application layer processing element 102 or transport layers 104, 106, and 108).

Queue manager 100 is associated with SAS application layer 102 to aid in managing the sequence of re-connect requests from multiple SAS devices. Queue manager 110 aids in rapidly locating one or more queued frames for a re-connected device. SAS transport layers 104, 106, and 108 and queue manager 110 operate cooperatively to retrieve queued SAS frames for a re-connecting SAS devices regardless of the order in which frames were previously queued for multiple active SAS devices. Responding to SAS devices 171-175 re-connecting allows the SAS device 100 to opportunistically utilize each established or re-established connection between any of the multiple transport layers and corresponding other SAS devices. If a SAS transport layer establishes a connection to a corresponding device and the device does not disconnect the established connection, the transport layer may continue to transfer the queued SAS frames to that SAS device to completion or until the device disconnects to perform further processing. If the SAS device disconnects the established connection in response to the transport layer's request to send frames, then the transport layers 104, 106, or 108 in conjunction with the queue manager 110 are operable to opportunistically send the previously queued frames whenever the identified SAS device eventually re-connects with the transport layer—regardless of the number of intervening connections established and frames transmitted.

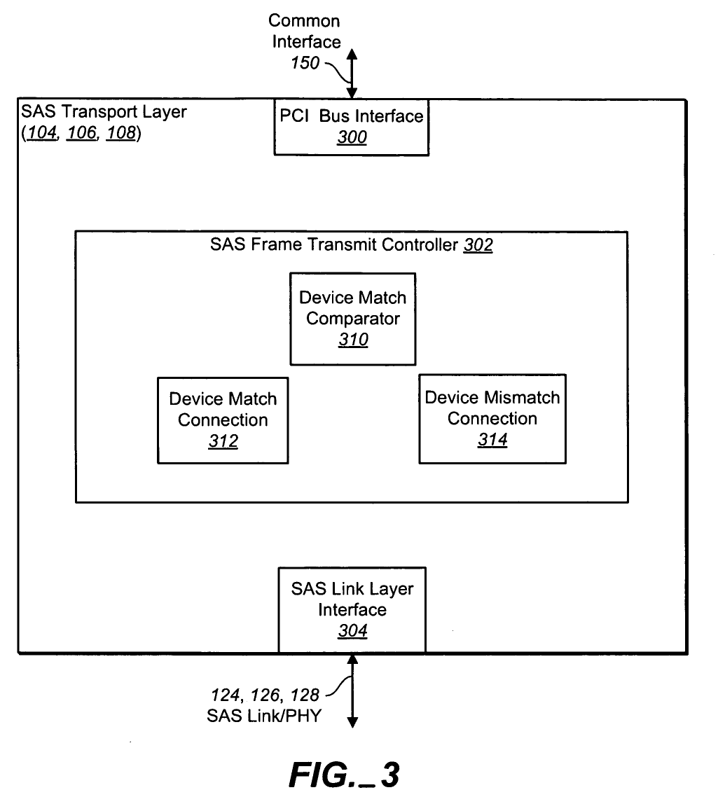

Further details of exemplary embodiments of queue manager 110 and SAS transport layers 104, 106, and 108 are provided herein below with reference to FIGS. 2 and 3. Those of ordinary skill in the art will readily recognize that numerous equivalent configurations and topologies equivalent to that shown in FIG. 1 may provide features and aspects hereof. In particular, any number of SAS transport layer processing elements may be associated with the SAS device 100. In addition, any of several well-known, commercially available, communication interface media and protocols who may be used in coupling SAS application layer 102 to the multiple SAS transport layer processing elements 104, 106, and 108. Still further, the processing elements providing SAS application layer 102 functionality and those providing SAS transport layers 104, 106, and 108 functionality may be any of several processing elements including custom application specific integrated circuits (“ASIC”) as well as suitably programmed instructions operable in general or special purpose processors. Still further, queue manager 110 may be operable within the same processing element used for SAS application layer 102 functionality or may be embodied within a distinct processing element as a matter of design choice.

FIG. 2 is a block diagram providing additional details of an exemplary embodiment of queue manager 110. Queue manager 110 may provide any suitable structure and processes for queuing generated SAS frames such that each queued frame is associated with an identified SAS device to which the frame is to be transmitted. Queue manager 110 preferably maintains the chronological order of frames queued for a particular identified device and maintains a structure that permits frames for one device to be retrieved and unqueued rapidly without impacting other queued frames for other SAS devices. Any of several well known queue management techniques, structures and processes may be utilized for maintaining such an association between an identified SAS device and each queued frame.

In one exemplary embodiment, multiple device queues may be maintained by queue manager 110, one for each SAS device. Device 0 queue 210, device 1 queue 212, and device N queue 214 represent three exemplary queue structures each corresponding to an identified SAS device. As generated SAS frames are received by queue manager 110 from SAS application layer 102 of FIG. 1, the SAS frame may be entered into the appropriate queue corresponding to the identified device. Within each device queue, frames may be maintained in the chronological order in which they are received by queue manager 110.

FIG. 3 is a block diagram providing additional details of an exemplary embodiment of SAS transport layer processing elements 104, 106, and 108. Bus interface element 300 provides connectivity to common interface 150 in accordance with the protocol standards appropriate to common interface 150. For example, PCI bus or AMBA AHB bus interface components may provide the desired functionality of bus interface 300. Alternatively, as noted above, transport layers 104, 106, and 108, queue manager 110 and application layer 102 may communicate through well known interprocess communication techniques where all are embodied within a single processing element.

SAS link layer interface element 304 provides functionality to apply SAS frames to an associated SAS link layer 124, 126, or 128 for transmission of generated SAS frames to a corresponding identified SAS device. SAS frame transmit controller 302 performs processing to retrieve SAS frames for transmission to the corresponding SAS device and to apply the retrieved frames to the link layer 124, 126, or 128. A transport layer (104, 106, or 108) receives a request from a SAS application layer through bus interface element 300. Frames generated by the application layer are queued within the queue manager 110 of FIGS. 1 and 2. Having received a request from an application layer 102 of FIG. 1, transport layer 104, 106, or 108 retrieves a next queued frame for the identified device and attempts to transfer it to the identified device. As noted above, the device may refuse/reject the frame transmission and require further preparation to receive transmitted frames. The device may then disconnect the established connection. Upon such a re-connection (re-select) sensed by the transport layer processing element, SAS frame transmit controller 302 is adapted to locate queued frames for the re-connecting device regardless of which device was last connected to the transport layer.

As discussed further herein below, the transport layer may record information regarding the last contacted device. Device match comparator element 310 within transmit controller 302 determines whether the device ID of the last contacted device matches the ID of the device now re-connected to the transport layer. As noted above, an indicator within the SAS application layer may indicate the identity of the SAS device to which the application layer last directed a request. Device match comparator 310 is responsive to a re-connection by a SAS device to determine whether the re-connected device ID matches that of the last contacted device. If the IDs match, device match connection processing element 312 retrieves more SAS frames from the queue manager and applies the retrieved frames to the link layer interface element 304 (that in turns transmits the frames to the corresponding SAS device). If the device ID of the last contacted device indicates another device ID (e.g., due to pseudo-random delays in this SAS device preparing to receive generated frames and due to pseudo-random delays associated with arbitration in re-connection), device mismatch connection element 314 is operable to retrieve previously queued SAS frames from the queue manager for this mismatched SAS device and forward the retrieved frames to the corresponding, now re-connected SAS device.

As noted above, the opportunistic transmission of frames from the transport layer to a re-connecting device whenever the unexpected device happens to win an arbitration process improves overall performance. The device mismatch connection element 314 in particular enables such opportunistic transfer of generated SAS frames to another SAS device whenever the a re-connected SAS device that is not the last connected device wins arbitration on the arbitrated SAS domain. By contrast, prior techniques would ignore the arbitration winner re-connection if it was not the last connected device and hence waste an opportunity to forward queued frames to a ready and waiting device.

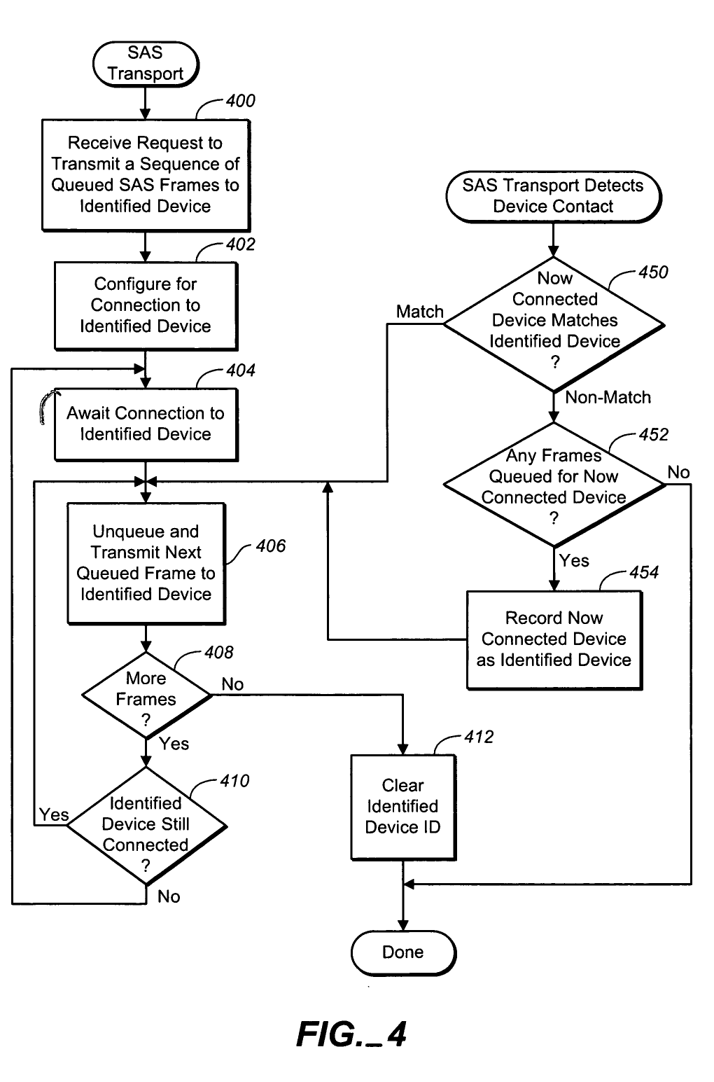

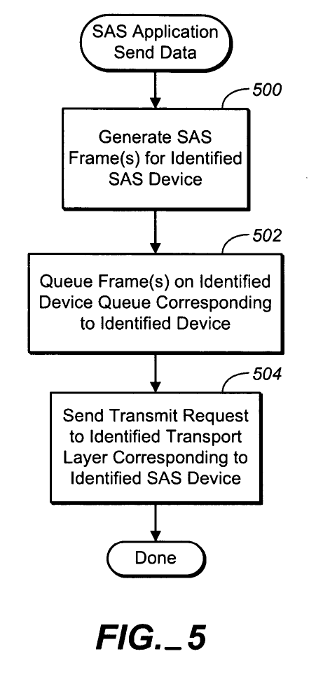

FIGS. 4 and 5 are flowcharts describing operation of a SAS transport layer (FIG. 4) and a SAS application layer (FIG. 5) each operable in accordance with features and aspects hereof.

In particular, FIG. 4 is a flowchart describing operation of a SAS transport layer processing element in accordance with features and aspects hereof (i.e., SAS transport layers 104, 106, and 108 of FIG. 1). The method of FIG. 4 is operable in response to receipt of a request to transmit one or more SAS frames from the SAS application layer to an identified SAS target device. Element 400 is first operable to receive a request from a SAS application layer to transmit a sequence of one or more related SAS frames and/or commands to an identified SAS device. Such a request first requires that the transport layer establish a connection with the identified SAS device. Element 402 therefore configures the transport layer to prepare for establishment of such a connection to the identified SAS device. In particular, the identity (device ID) of the identified device may be stored in a memory associated with the transport layer. Other preparations to transmit to the identified SAS device may also be performed by operation of element 402.

Element 404 then awaits establishment of a connection to the identified device or, as explained further herein below, another SAS device that establishes a connection by winning arbitration in the arbitrated SAS domain coupled to this transport layer (through an appropriate link/PHY layer). Eventually, when some SAS device successfully completes establishment of a connection, element 406 is next operable two unqueue and transmit a next queued frame for the identified device with which the transport layer is presently connected. Element 408 then determines if more frames remain in the queue for transmission to this presently identified, connected SAS device. If not, the process continues with element 412 clearing the previously stored indicia of the presently identified device. In other words, no SAS device is presently connected to this SAS transport layer. The transport layer will commence processing anew when another request is received from an application layer or when another SAS device completes its connection to this SAS transport layer processing.

If the element 408 determines that additional frames remained queued for the presently identified, connected SAS device, element 410 is next operable to determine whether the device is still properly connected to this SAS layer processing element. In accordance with SCSI standards, a device may issue a disconnect to release the SCSI communication medium for any of several reasons if it requires further processing or buffer management before being prepared to accept further transmissions. If element 410 determines that the identified device is still connected to this transport layer, processing continues looping back to element 406 to unqueue a next frame and transmit the unqueued next frame to the identified, presently connected, SAS device. If element 410 determines that the device that was presently connected has disconnected, processing returns to element 404 to await connection (i.e., SCSI re-connection or re-selection) by the identified SAS device to permit completion of transmission of queued frames.

As noted above, element 404 is operable in the transport layer to await completion of a connection to a particular identified SAS device. As discussed further herein above, multiple SAS devices may be in various states of processing and may attempt to reconnect with the transport layer substantially simultaneously through the arbitrated SAS domain topology. Arbitration features within the SAS domain coupled with the pseudo-random delays associated with processing in each SAS device means that the order in which devices attempt to re-connect may bear no relationship to the order in which the transport layer attempted initial connection. Elements 450 through 454 are therefore operable to determine which device has established a connection with the transport layer. Elements 450 through 454 are operable in response to detecting a successful connection from one of the multiple SAS devices coupled to this transport layer through the arbitrated SAS domain. The successfully connected SAS device is the device that won arbitration where multiple SAS devices were ready for transmission substantially simultaneously.

In particular, element 450 is first operable in response to detecting a successfully connected SAS device to determine whether the now connected device matches the identity of the previously identified SAS device. The previously identified SAS device is the device which is presently configured for connection within the SAS transport layer. If the presently configured device identification (i.e., device ID) matches that of the now connected device, processing continues at element 406 as discussed above to commence transmission of previously queued frames. If the now connected device ID does not match the ID of the previously identified device presently configured in the SAS transport layer for transmission of frames, element 452 next determines whether the now connected device has any frames presently queued within the associated queue manager. If no frames are presently queued for the now connected device, processing of the method completes with no frames to be transmitted to the presently connected SAS device. Other devices still awaiting an opportunity to win arbitration and successfully re-connect or initially connect will eventually win such an arbitration and thereby successfully establish a connection for purposes of receiving queued frames. If element 452 determines that frames are presently queued in the queue manager for the now connected device, element 454 is operable to record the now connected device as the identified device connected to the transport layer for purposes of unqueuing and transmitting queued frames. Recording such information may include simple recordation of the device ID associated with the now connected device. Such information may be stored in any suitable memory associated with the SAS transport layer processing element. Substituting the now connected device for a previously identified device preferably does not eliminate any information of the previously identified device as regards to queued frames and the need to eventually establish a connection with the previously identified device for purposes of transmitting those queued frames.

Those of ordinary skill in the art will recognize that the processing of elements 450 through 454 in conjunction with that of 400 through 412 represent both match connection processing and mismatch connection processing discussed above with respect to FIG. 2. Mismatch connection processing is represented by the processing of all elements 400 through 412 and that of elements 450 through 454 while match connection processing excludes the processing associated with elements 452 and 454 of FIG. 4 because the identity of the newly connected device matches that of the identified device previously supplied by the received request from the application layer.

FIG. 5 is a flowchart describing operation of a SAS application layer processing element in accordance with features and aspects hereof. Element 500 is first operable to generate one or more frames for transmission to an identified SAS device. Any number of frames may be generated for a particular sequence of information exchange. Frames may also include SAS commands in addition to data frames. Element 502 is next operable two queue the generated frames on an identified device queue corresponding to the identified SAS device intended to receive the queued frames. As noted above, the queue manager, in accordance with features and aspects hereof, may maintain multiple queues—one for each identified SAS target device to receive frames. Thus, queuing frames for one target device does not interfere with queuing operations for another target device. Lastly, element 504 is operable in the application layer to send a transmit request message to an identified transport layer corresponding to the identified SAS device intended to receive who the queued frames.

Those of ordinary skill in the art will recognize a variety of equivalent methods and processes for performing SAS transport layer processing and SAS application layer processing in accordance with features and aspects hereof. The flowcharts of FIGS. 4 and 5 are therefore intended merely as representative of possible, exemplary embodiments for such processing.

While the invention has been illustrated and described in the drawings and foregoing description, such illustration and description is to be considered as exemplary and not restrictive in character. One embodiment of the invention and minor variants thereof have been shown and described. Protection is desired for all changes and modifications that come within the spirit of the invention. Those skilled in the art will appreciate variations of the above-described embodiments that fall within the scope of the invention. In particular, those of ordinary skill in the art will readily recognize that features and aspects hereof may be implemented equivalently in electronic circuits or as suitably programmed instructions of a general or special purpose processor. Such equivalency of circuit and programming designs is well known to those skilled in the art as a matter of design choice. As a result, the invention is not limited to the specific examples and illustrations discussed above, but only by the following claims and their equivalents.

What is claimed is:

1. A SAS device comprising:
a SAS application layer processing element; and
a plurality of SAS transport layer processing elements each communicatively coupled to the SAS application layer processing element and wherein each SAS transport layer processing element is adapted to exchange information received from the SAS application layer processing element with one or more of the other SAS devices through an arbitrated SAS domain interface,
wherein each SAS transport layer processing element is adapted to retrieve a next frame to transmit to a winning device of the plurality of other SAS devices each time the winning device wins arbitration on the arbitrated SAS domain.

2. The SAS device of claim 1 further comprising:
a queue manager communicatively coupled to the SAS application layer processing element and coupled each of the plurality of SAS transport layer processing elements and adapted to queue SAS frames generated by the SAS application layer processing element.

3. The SAS device of claim 2
wherein each SAS transport layer processing element is operable to retrieve a next queued SAS frame from the queue manager when the winning device wins arbitration regardless of the order in which the SAS frames are queued in the queue manager for other SAS devices.

4. The SAS device of claim 2 wherein the queue manager further comprises:
a plurality of SAS frame queues each associated with a corresponding one of the other SAS devices.

5. A SAS transport layer coupled to an associated SAS application layer and coupled to a SAS device through an arbitrated SAS domain, the SAS transport layer further comprising:
a SAS application layer interface element adapted to couple the SAS transport layer to a SAS application layer;
a SAS link layer interface to couple the SAS transport layer to a SAS domain; and
a SAS frame transmit controller for retrieving a next SAS fame for transmission to the associated SAS device in response to the associated SAS device winning arbitration through the arbitrated SAS domain regardless of which SAS device the SAS frame transmit controller was last contacted by the SAS frame transmit controller.

6. The SAS transport layer of claim 5 wherein the SAS frame transmit controller further comprises:
a match comparator to determine whether the SAS transport layer is presently requesting transmission of a SAS frame to the associated SAS device;
a match connection module to retrieve a next frame from the SAS application layer in response to a determination that the SAS transport layer is presently requesting transmission of a SAS frame to the associated SAS device; and
a mismatch connection module to request a next frame for the SAS device from the SAS application layer in response to a determination that the SAS transport layer is presently requesting transmission of a SAS frame to the another SAS device.

7. In a SAS transport layer a method for obtaining a next SAS frame for transmission to an identified SAS device coupled to the SAS transport layer through an arbitrated SAS domain, the method comprising:
receiving a request from the SAS application layer to transmit a SAS frame to the identified SAS device;
attempting to connect to the identified SAS device;
detecting a connection between the transport layer and a winning SAS device that won an arbitration process on the arbitrated SAS domain; and
transmitting a next SAS frame to the winning SAS device regardless of whether the winning SAS device is the same device as the identified SAS device.

8. The method of claim 7 wherein SAS frames to be transmitted are queued in a queue manager communicatively coupled to the SAS transport layer and wherein the step of transmitting further comprises:
unqueuing the next frame to be transmitted from a first queue in the queue manager if the winning SAS device is the same device as the identified device wherein the first queue is associated with the identified SAS device; and
unqueuing the next frame to be transmitted from a second queue in the queue manager if the winning SAS device is not the same device as the identified device wherein the second queue is associated with the winning SAS device.

9. The method of claim 7 wherein the step of detecting further comprises:
detecting a re-connect from the winning SAS device.
